(19) United States
(12) Patent Application Publication
(10) Pub. No.: US 2025/0224904 A1
(43) Pub. Date: Jul. 10, 2025

(54) INFORMATION PROCESSING APPARATUS USING GENERATIVE AI, CONTROL METHOD THEREFOR, AND STORAGE MEDIUM STORING PROGRAM THEREFOR

(71) Applicant: CANON KABUSHIKI KAISHA, Tokyo (JP)

(72) Inventor: NAO DOBASHI, Kanagawa (JP)

(21) Appl. No.: 19/008,026

(22) Filed: Jan. 2, 2025

(30) Foreign Application Priority Data
Jan. 5, 2024 (JP) 2024-000697

(51) Int. Cl. G06F 3/12; G06T 11/60

(52) U.S. Cl. CPC G06F 3/1204; G06F 3/1276; G06T 11/60

(57) ABSTRACT

A mechanism capable of displaying edited image data to which an editing process has been applied using a text received from a user and a generative AI on a display. A non-transitory computer-readable storage medium storing a causing an information processing apparatus to execute a method, the method including a display step of displaying image data on a display of the information processing apparatus, a reception step of receiving input of a text from a user, and a display control step of displaying edited image data that is obtained by applying an editing process to the image data using the text received in the reception step and a generative AI on the display.

### BACKGROUND OF THE INVENTION

### Field of the Invention

The present invention relates to an information processing apparatus using a generative AI, a control method therefor, and a storage medium storing a program therefor.

### Description of the Related Art

In recent years, conversational AIs, such as a chatbot and a generative AI, have been rapidly developed. With this development, various services using a conversational AI have been provided. For example, there is a known printing assistance system capable of performing automatic print setting of a print job via a chatbot in a print service (for example, see Japanese Patent Laid-Open Publication No. 2019-207513 (counterpart of US 20190369924 A1)).

However, when a text is input in a format other than a predesignated format, the printing assistance system disclosed in the above publication cannot accurately (appropriately) interpret the input text, which makes it difficult to perform automatic print setting of a print job.

### SUMMARY OF THE INVENTION

The present invention provides a mechanism capable of displaying edited image data to which an editing process has been applied using a text received from a user and a generative AI on a display device.

Accordingly, an aspect of the present invention provides a non-transitory computer-readable storage medium storing a computer program causing an information processing apparatus to execute a method, the method including displaying image data on a display of the information processing apparatus, receiving input of a text from a user, and displaying edited image data that is obtained by executing, using the text received and a generative AI, an editing process to the image data on the display.

According to the present invention, it is possible to display the edited image data to which the editing process has been applied using the text received from the user and the generative AI on the display device.

Further features of the present invention will become apparent from the following description of exemplary embodiments with reference to the attached drawings.

### BRIEF DESCRIPTION OF THE DRAWINGS

FIG. 1 is a block diagram illustrating an example of a network configuration of a print system according to an embodiment of the present invention.

FIGS. 2A and 2B are block diagrams respectively showing hardware configurations of a computer and a generative AI server shown in FIG. 1.

FIG. 3 is a block diagram showing a hardware configuration of a printer shown in FIG. 1.

FIGS. 4A and 4B are block diagrams respectively showing software configurations of the computer and the generative AI server shown in FIG. 1.

FIG. 5 is a view showing an example of a UI (User Interface) image displayed by the printer driver shown in FIG. 4A.

FIG. 6 is a view showing an example of an image of a print application UI.

FIG. 7 is a flowchart showing an example of a data interpretation process executed in the generative AI server.

FIG. 8 is a view showing an example of a relationship between print setting list data, a propensity score, a similarity value score, and post-interpretation data in the data interpretation process.

FIG. 9 is a flowchart showing an example of a print process executed by the print application.

FIG. 10A is a view showing an example of images of the print application UI that are sequentially displayed during the print process executed by the print application.

FIG. 10B is a view showing an example of the images of the print application UI that are sequentially displayed during the print process executed by the print application.

### DESCRIPTION OF THE EMBODIMENTS

Hereafter, embodiments according to the present invention will be described in detail by referring to the drawings. However, the configurations described in the following embodiments are merely examples, and the scope of the present invention is not limited by the configurations described in the embodiments. For example, each unit constituting the present invention can be replaced with any configuration capable of exhibiting the same function. In addition, an arbitrary constituent may be added.

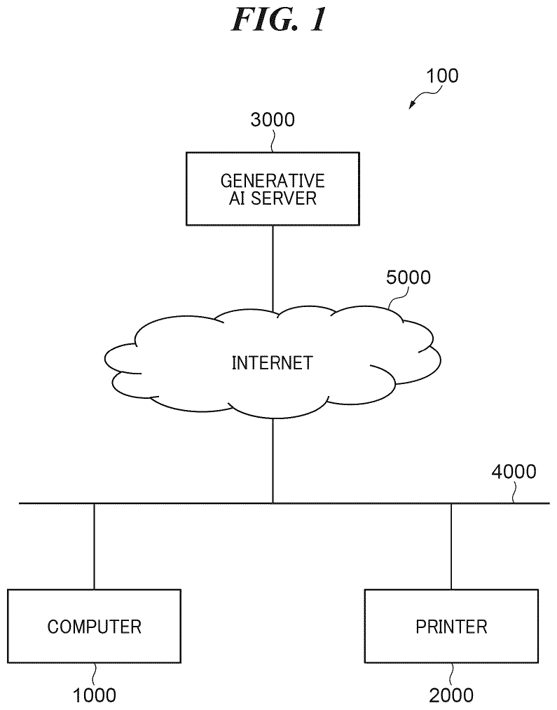

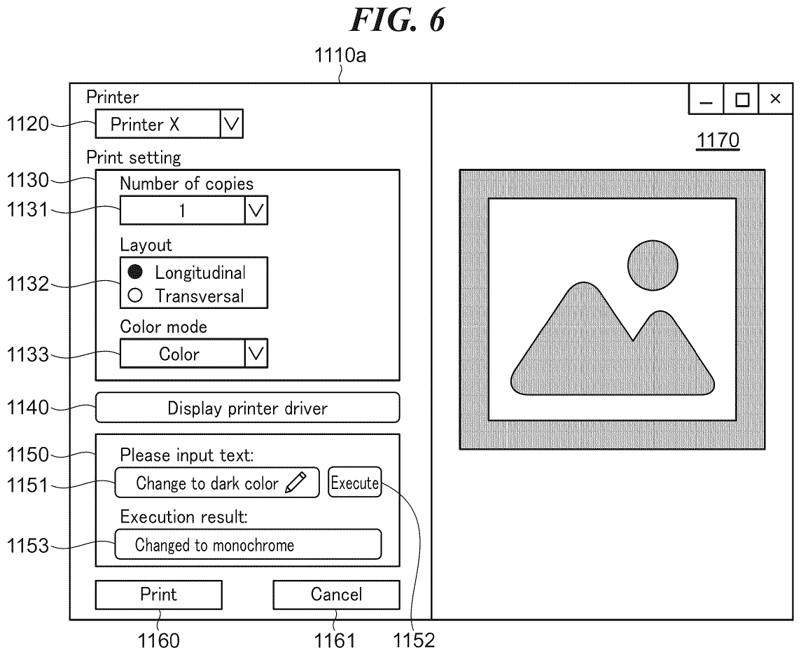

FIG. 1 is a block diagram showing an example of a network configuration of a print system according to an embodiment of the present invention. As shown in FIG. 1, the print system 100 includes a computer 1000 as a terminal apparatus, a printer (printing apparatus) 2000 capable of printing, and a generative AI server (server) 3000. For example, the computer 1000 and the printer 2000 are disposed in an office and are connected to each other via an intracompany network 4000 so as to be mutually communicable. The intracompany network 4000 is connected to the external Internet 5000 via a router (not shown). The generative AI server 3000 is connected to the computer 1000 and the printer 2000 via the Internet 5000 and the intracompany network 4000 so as to be mutually communicable. The generative AI server 3000 is a server managed by a business operator that provides a generative AI service. In this embodiment, the generative AI server 3000 and a generative AI control 1150 shown in FIG. 6 on the computer 1000 may be collectively referred to as a “generative AI system”. The generative AI server 3000 and the generative AI control 1150 may be separate from each other or may exist integrally on the same hardware. The intracompany network 4000 may be connected by wire or by wireless.

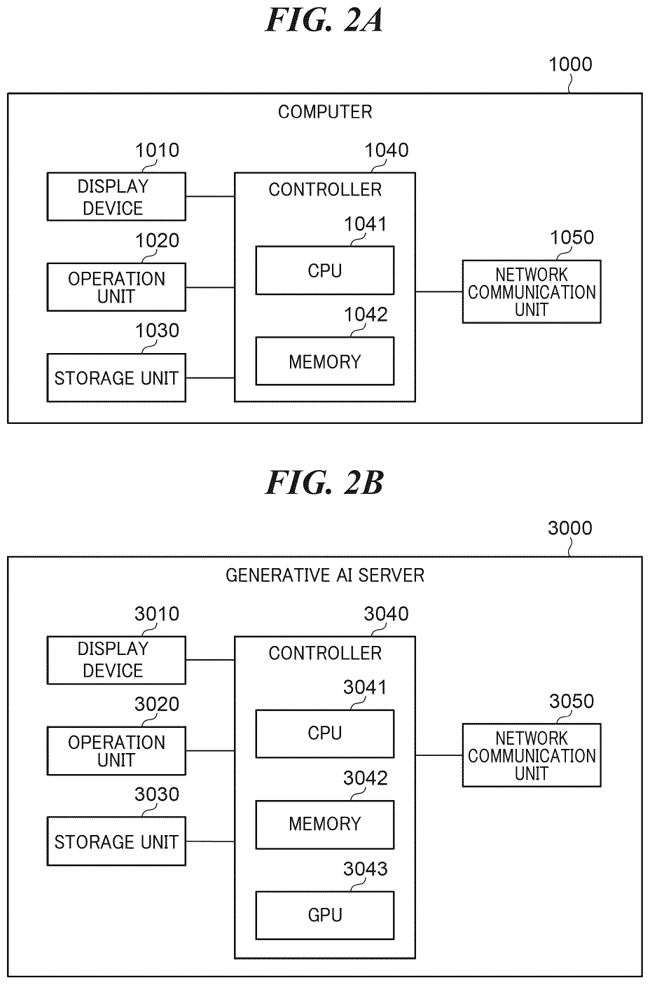

FIGS. 2A and 2B are block diagrams respectively showing hardware configurations of the computer 1000 and the generative AI server 3000 shown in FIG. 1. As shown in FIG. 2A, the computer 1000 includes a display device (display unit) 1010, an operation unit 1020, a storage unit 1030, a controller 1040, and a network communication unit 1050, which are connected so as to be mutually communicable. The computer 1000 is not particularly limited, and for example, a desktop or notebook personal computer, a tablet terminal, a smartphone, or the like can be used. The controller 1040 is configured by a CPU (Central Processing Unit) 1041 and a memory 1042, and controls the entire computer 1000. The display device 1010 is configured by a display such as a liquid crystal panel, for example, and can display an image, for example. The operation unit 1020 is configured by, for example, a mouse, a keyboard, etc., and accepts input operations by a user. The storage unit 1030 is configured by a storage medium such as a hard disk or an SSD, and stores various programs (software) necessary for the computer 1000 to operate. A program is loaded into the memory 1042 as needed and executed by the CPU 1041. The programs include a program for causing the CPU 1041 (computer) to execute sections and units of the print system 100 (a control method for the print system). The programs may not be stored in the computer 1000. The programs may be stored in the printer 2000 or the generative AI server 3000, or may be distributed and stored in the computer 1000, the printer 2000, and the generative AI server 3000. The network communication unit 1050 inputs and outputs data to and from an external apparatus via an external network.

As shown in FIG. 2B, the generative AI server 3000 includes a display device (display unit) 3010, an operation unit 3020, a storage unit 3030, a controller 3040, and a network communication unit 3050, which are mutually connected so as to be communicable. The controller 3040 is configured by a CPU 3041 and a memory 3042, and controls the entire generative AI server 3000. Thus, the hardware configuration of the generative AI server 3000 is substantially similar to the hardware configuration of the computer 1000. Therefore, in this embodiment, the description of the hardware configuration of the generative AI server 3000 is omitted. The generative AI server 3000 preferably includes a GPU (Graphics Processing Unit) 3043.

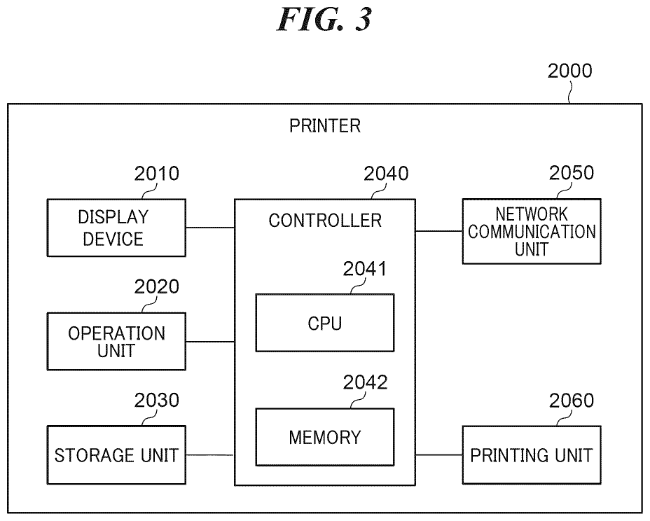

FIG. 3 is a block diagram showing a hardware configuration of the printer 2000. As shown in FIG. 3, the printer 2000 includes a display device (display unit) 2010, an operation unit 2020, a storage unit 2030, a controller 2040, a network communication unit 2050, and a printing unit 2060, which are connected so as to be mutually communicable. The printer 2000 is not particularly limited as long as it has a print function, and for example, an MFP (a multi-function printer/peripheral (MFP) or an SFP (Single Function Printer) can be used. The controller 2040 is constituted by a CPU 2041 and a memory 2042, and controls the entire printer 2000. The display device 2010 is configured by a display such as a liquid crystal panel, for example, and can display an image, for example. The operation unit 2020 is configured by a touch panel, various buttons, etc., and accepts input operations by a user. The storage unit 2030 is configured by a storage medium such as a hard disk or an SSD, and stores various programs (software) necessary for the printer 2000 to operate. A program is loaded into the memory 2042 as needed and executed by the CPU 2041. The network communication unit 2050 inputs and outputs data to and from an external apparatus via an external network. The printing unit 2060 converts digital data stored in the storage unit 2030 or the memory 2042 into an image and prints the image on the print sheet in accordance with an instruction from the controller 2040. The printing method is not particularly limited, and for example, an ink method, a toner method, or other methods can be used.

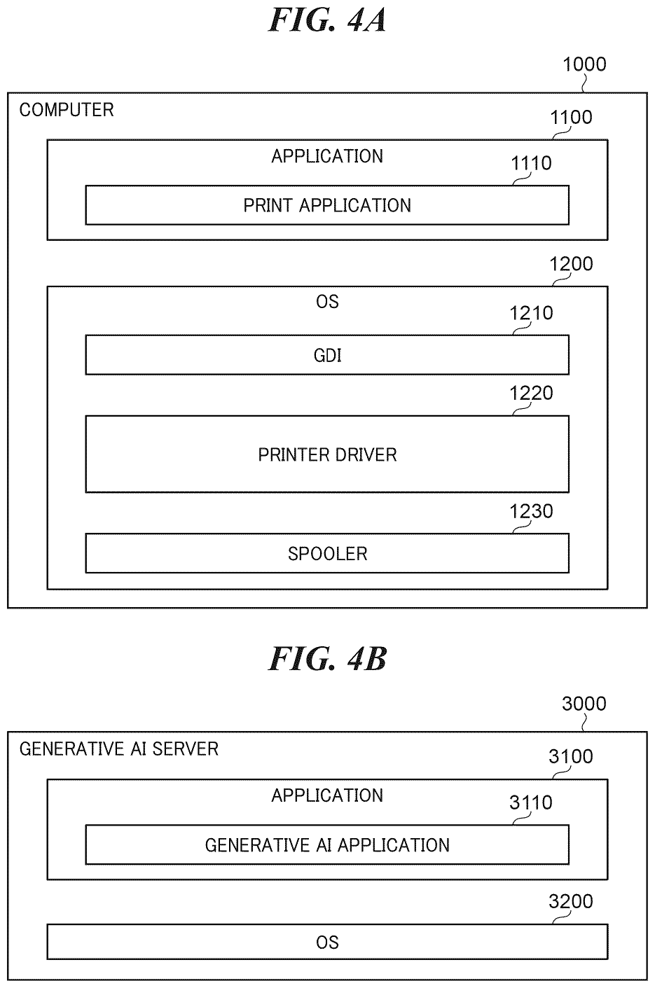

FIGS. 4A and 4B are block diagrams respectively showing software configurations of the computer 1000 and the generative AI server 3000 shown in FIG. 1. FIG. 4A is the block diagram showing modules related to printing in the software configuration of the computer 1000. As shown in FIG. 4A, the computer 1000 includes an application 1100 and an OS (Operating System) 1200. The application 1100 includes arbitrary software such as security software, spreadsheet software, and browser software, and includes a print application 1110 in FIG. 4A. The print application 1110 is an application having a print function. The print application 1110 is not particularly limited, and for example, is the spreadsheet software or the browser software having the print function. When the print function of the print application 1110 is executed in response to a user operation, information displayed on the display device 1010 of the computer 1000 is transmitted to the printer 2000, and printing is performed. The print function is achieved by calling an interface of a GDI (Graphic Device Interface) 1210 described below.

The OS 1200 is software that controls basic operations of the computer 1000. The OS 1200 includes the GDI 1210, a printer driver 1220, and a spooler 1230. The application 1100 and the printer driver 1220 are all managed by the OS 1200, and can be used by being installed in the OS 1200. The GDI 1210 is a component inside the OS 1200 that provides an interface related to drawing such as printing to the outside. The printer driver 1220 displays a print setting for printing by the printer 2000 as a UI (User Interface). The printer driver 1220 generates drawing data (PDL (Page Description Language) data) that can be interpreted by the printer 2000 in printing. The spooler 1230 performs a process to transmit the PDL data generated by the printer driver 1220 to the printer 2000.

FIG. 4B is a block diagram showing a software configuration involved in an interpretation process of the generative AI server. As shown in FIG. 4B, the generative AI server 3000 includes an application 3100 and an OS 3200. Note that the software configuration of the OS 3200 is substantially the same as that of the OS 1200, and thus a description of the OS 3200 will be omitted here. The application 3100 includes arbitrary software, and includes a generative AI application 3110 in FIG. 4B. The generative AI application 3110 is an application having a generative AI interpretation processing function. The generative AI application 3110 executes the interpretation process when the generative AI server 3000 receives interpretation instruction data instructing execution of the data interpretation process. The interpretation instruction data is Boolean type data that takes a value of True or False. When the value of the interpretation instruction data is True, the generative AI application 3110 executes the API that performs the data interpretation process and sets the value of the interpretation instruction data to False. On the other hand, the generative AI application 3110 does not execute the data interpretation process when the value of the interpretation instruction data is False.

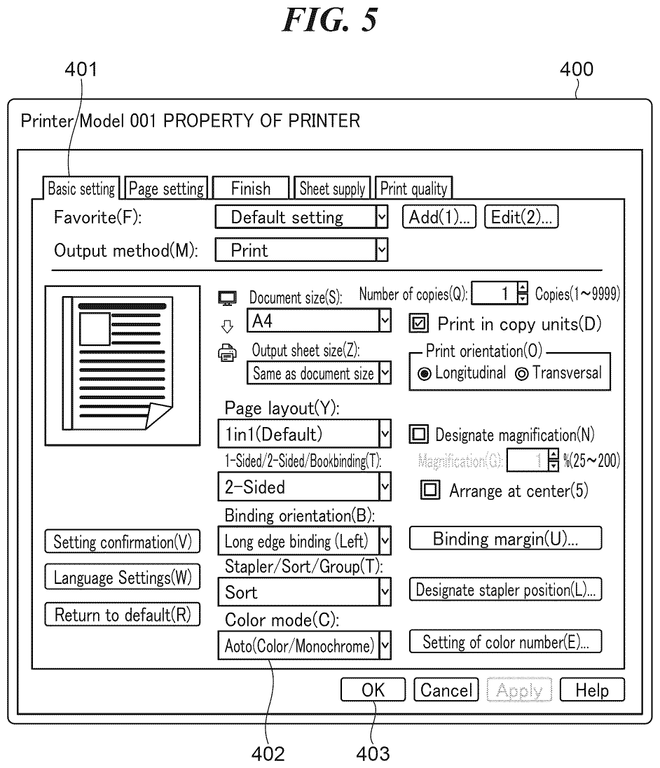

FIG. 5 is a view showing an example image of a UI (User Interface) displayed by the printer driver 1220. The UI 400 shown in FIG. 5 is displayed as an image on the display device 1010 by the printer driver 1220. The printer driver 1220 receives a display request from the print application 1110 or the spooler 1230 via the GDI 1210. A plurality of sheets called tabs that allow various settings are arranged on the UI 400. These tabs include a basic setting tab 401. In the basic setting tab 401, for example, a size of a document used for printing and a page layout of the document can be set. The basic setting tab 401 includes a color mode pull-down 402 and an OK button 403. In the color mode pull-down 402, “Color” for setting color printing and “Monochrome” for setting monochrome printing can be selected as a color mode set value (hereinafter, also referred to as a “set value”). Then, when the OK button 403 is pressed (pushed down) in a state where one of “Color” and “Monochrome” is selected, the selected state is set. Note that various pieces of setting information in the UI 400 are transmitted to the print application 1110 when the print application 1110 controls and are transmitted to the spooler 1230 when the spooler 1230 controls. After this transmission, the printer driver 1220 closes the UI 400.

FIG. 6 is a view showing an example of a UI image displayed by the print application. As shown in FIG. 6, the print application 1110 displays a print application UI 1110a as an image on the display device 1010, and receives input of output conditions including print conditions in printing by the printer 2000 (an input step). As described above, in this embodiment, the print application 1110 functions as an input unit that receives input of the output conditions. The print application UI 1110a includes a printer selection control 1120, a print setting control 1130, a printer driver control 1140, and a generative AI control 1150 as the print conditions. The print application UI 1110a may include output conditions other than of the print conditions. For example, when the printer 2000 can perform a stapling process, staple conditions for setting stapling positions and the number of staples may be included. In addition, when the printer 2000 can perform a cutting process, cutting conditions for setting a cutting position may be included. The print application UI 1110a includes a print button 1160, a cancel button 1161, and an image display area 1170.

In the printer selection control 1120, a list of printers that can be used by the computer 1000, that is, printers that can receive a print job from the computer 1000, is displayed on the UI on the basis of printer data stored in advance in the storage unit 1030. The user can select the printer 2000 as a transmission target to which the print job is transmitted by operating the printer selection control 1120. In FIG. 6, the name of the printer 2000 is “Printer X”.

The print setting control 1130 includes a number-of-copies control 1131, a layout control 1132, and a color mode control 1133. The number-of-copies control 1131 is an item for setting the number of copies to be printed. In FIG. 6, the number-of-copies control 1131 is set to “1”. The layout control 1132 is an item for selecting an orientation of printing on a sheet. In this embodiment, “Longitudinal” in which the printing direction is set to a longitudinal direction and “Transversal” in which the printing direction is set to a transversal direction can be selected. In FIG. 6, the layout control 1132 is set to “Longitudinal”. The color mode control 1133 is an item for selecting “Color” for setting color printing or “Monochrome” for setting monochrome printing. In FIG. 6, the color mode control 1133 is set to “Color”. Although the print setting control 1130 includes the number-of-copies control 1131, the layout control 1132, and the color mode control 1133 in the example shown in FIG. 6, this is not limiting. The print setting control 1130 may include at least one of these items. The print setting control 1130 may include, for example, an item for selecting a sheet size, an item for selecting single-sided printing or double-sided printing, and an item for selecting the number of pages to be arranged per sheet.

When the user operates (presses) the printer driver control 1140, the UI 400 of the printer driver corresponding to the “Printer X” displayed in the printer selection control 1120 is displayed. This allows the user to change the print set values on the UI 400. When the UI 400 is closed, the changed contents of the print set values in the UI 400 are stored in the storage unit 1030.

The generative AI control 1150 includes a text box 1151, an execution button 1152, and an execution result display box 1153. The text box 1151 is an output item for setting one of the output conditions. In the text box 1151, the user can input a text (a character string), which instructs to change a print color, for example, in a natural language such as English or Japanese. In FIG. 6, “Change to dark color” indicating that the print color is changed to a dark color is input in English in the text box 1151. The text box 1151 functions as a text reception section that receives input of a text from the user. The text input to the text box 1151 is not limited to the text instructing to change the print color, and may be any text instructing to change the print area, that is, to enlarge or reduce the print area. Then, the user can operate the execution button 1152 in the state where the text is input in the text box 1151. As a result, pre-interpretation data is transmitted to the generative AI server 3000. The pre-interpretation data includes data of the text input in the text box 1151 (hereinafter referred to as “text data”) and data of the print set values set in the print setting control 1130 (hereinafter referred to as “print setting list data”). The pre-interpretation data also includes the interpretation instruction data described above. In the execution result display box 1153, an execution result based on post-interpretation data obtained by the generative AI server 3000 interpreting the pre-interpretation data is displayed as a text. In FIG. 6, “Changed to monochrome” is displayed as the execution result in the execution result display box 1153.

In the image display area 1170, a preview of the print image is displayed. As the preview image, an image obtained by reflecting the print set values set in the print setting control 1130 and the generative AI control 1150 of the print application UI 1110a to the image data of the print target is displayed. This allows the user to check a printed matter to be printed by the printer 2000 before the printed matter is obtained. When the user wants to print the preview image, the user can transmit the print job to the printer 2000 by operating the print button 1160. Thus, the printer 2000 can execute the print job and output the printed matter.

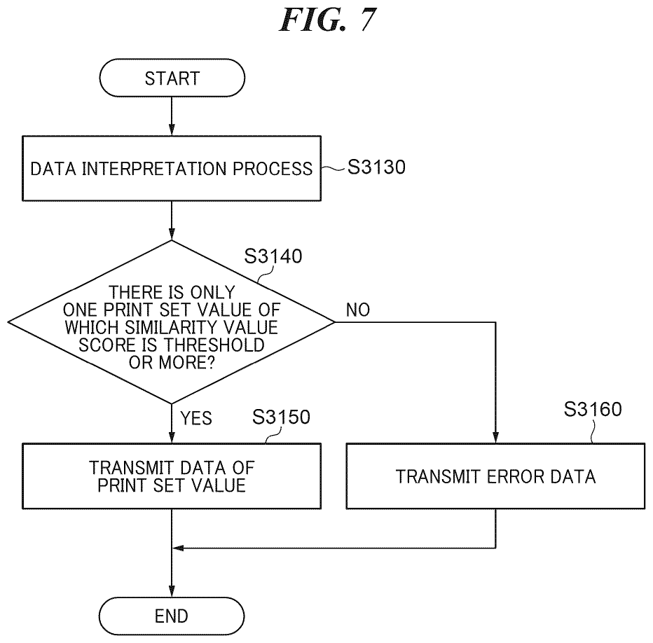

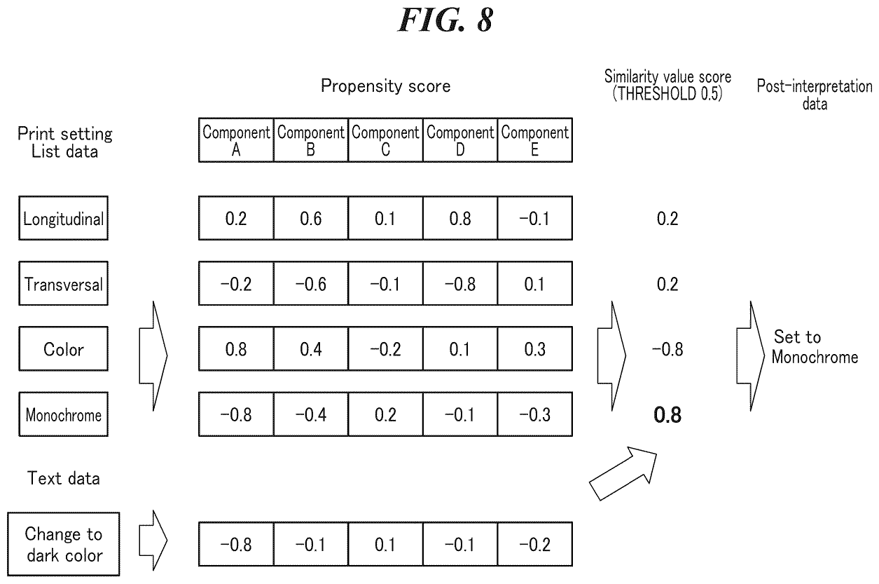

FIG. 7 is a flowchart showing an example of the data interpretation process performed by the generative AI server. FIG. 8 is a view showing an example of a relationship among the print setting list data, a propensity score, a similarity value score, and post-interpretation data in the data interpretation process. All the steps in the flowchart shown in FIG. 7 are achieved by the CPU 3041 executing the application 3100 loaded into the memory 3042 from the storage unit 3030 of the generative AI server 3000. The process of the flowchart shown in FIG. 7 is started when the network communication unit 3050 receives the pre-interpretation data. As shown in FIG. 7, in a step S3130, the CPU 3041 of the generative AI server 3000 reads the pre-interpretation data and executes the data interpretation process to interpretate the pre-interpretation data. The data interpretation process will be described with reference to FIG. 8.

As shown in FIG. 8, the print setting list data includes “Longitudinal”, “Transversal”, “Color”, and “Monochrome”. The text data “Change to dark color” is also included. First, the generative AI server 3000 receives the print setting list data and the text data. The generative AI server 3000 can interpret the print setting list data on the basis of the data designated in advance in the generative AI server 3000. On the other hand, since the text data is arbitrarily input by the user, interpretation based on data designated in advance in the generative AI server 3000 may be difficult.

The CPU 3041 then calculates a propensity score for each data. When the propensity score is calculated, the print setting list data and the text data are decomposed into components A, B, C, D, and E, respectively. As a result, numerical vector data of the components A to E are obtained as propensity scores. Then, the propensity scores of the print setting list data and the text data are calculated (digitized) on the basis of a learned model so that the difference between data is relatively large. For example, the components A to E about “Monochrome” are “−0.8”, “−0.4”, “0.2”, “−0.1”, and “−0.3”, respectively. Further, the components A to E about “Change to dark color” are “−0.8”, “−0.1”, “0.1”, “−0.1”, and “−0.2”, respectively. In this way, in this embodiment, the CPU 3041 functions as a primary data conversion unit that digitizes the print setting list data and the text data on the basis of the learned model and converts them into primary data (a primary data conversion step). In the generative AI server 3000, a part functioning as the primary data conversion unit may be provided separately from the CPU 3041. The learned model is not particularly limited, and for example, Transformer can be used. The Transformer can calculate the propensity scores of the print setting list data and the text data so that the difference between data is as large as possible. The components A to E are not particularly limited, and for example, the component A can be “beauty”, the component B can be “linearity”, the component C can be “sweetness”, the component D can be “verticality”, and the component E can be “joyfulness” so that a human can easily interpret them.

Next, the CPU 3041 compares the propensity scores of the print setting list data and the propensity score of the text data to calculate a mutual similarity value scores (closeness). For the calculation of the similarity value score, for example, a method such as cosine similarity, inner product, or Mahalanobis distance can be used. The similarity between the propensity score of the print setting list data and the propensity score of the text data is higher as the similarity value score is closer to 1, is lower as the similarity value score is closer to −1, and correlation is lower as the similarity value score is closer to 0. In FIG. 8, the similarity value score between “Longitudinal” and “Change to dark color” is “0.2”. The similarity value score between “Transversal” and “Change to dark color” is “0.2”. The similarity value score between “Color” and “Change to dark color” is “−0.8”. The similarity value score between “Monochrome” and “Change to dark color” is “0.8”. When a threshold of the similarity value score in determining that the propensity score of the print setting list data is similar to the propensity score of the text data is set to “0.5”, for example, the CPU 3041 can determine that “Monochrome” is similar to “Change to dark color”. This is because the similarity value score between “Monochrome” and “Change to dark color” is “0.8” which is more than the threshold “0.5”.

Next, the CPU 3041 generates post-interpretation data by interpreting “Change to dark color” as “Set to monochrome”. This data of “Set to monochrome” is processable by the printer 2000. As described above, in this embodiment, the CPU 3041 also functions as a secondary data conversion unit that converts the text data “Change to dark color”, which is the primary data, into secondary data “Set to monochrome” that is processable by the printer 2000 (a secondary data conversion step). In the generative AI server 3000, a part functioning as the secondary data conversion unit may be provided separately from the CPU 3041.

As shown in FIG. 7, in a step S3140, the CPU 3041 of the generative AI server 3000 compares the propensity scores of the print setting list data and the propensity score of the text data to calculate the similarity value scores as described above. The CPU 3041 then determines whether there is only one print set value (print setting list data) of which the calculation result is equal to or more than the threshold. As a result of the determination in the step S3140, when it is determined that there is only one print set value, the process proceeds to a step S3150. On the other hand, as a result of the determination in the step S3140, when it is determined that there is not only one print set value, that is, there are a plurality of print set values, the process proceeds to a step S3160.

In the step S3150, the CPU 3041 transmits the data of the print set value determined to be equal to or more than the threshold in the step S3140 to the computer 1000 that is the data transmission source of the print setting list data and the text data. The print setting value data is the above-described data of “Set to monochrome” in this embodiment. After the step S3150 is performed, the process is terminated.

In the step S3160, the CPU 3041 transmits error data to the computer 1000. Then, the error data is displayed on the display device 1010 of the computer 1000. The error data is not particularly limited, and for example, a message indicating “Interpretation of text data is impossible” may be used. Further, a candidate of the print set value may be displayed on the display device 1010 instead of the text data. As described above, in this embodiment, the display device 1010 functions as a notification unit that notifies the user of failure when the conversion of the primary data or the conversion of the secondary data is unsuccessful. Thus, the user can recognize that the text data has not been automatically converted into data interpretable by the printer 2000. The notification unit is not limited to be included in the computer 1000, and may be included in at least one of the computer 1000, the generative AI server 3000, and the printer 2000. After the step S3160 is performed, the process is terminated.

The message of the error data in the print system 100 is not limited to the message indicating “Interpretation of text data is impossible”, and for example, a message indicating “Setting of driver or printer is impossible” can be displayed. In this case, it is preferable to display a candidate of a driver or a printer of which setting is possible. Further, as the display of the error data in the print system 100, it is also possible to display that “Option setting (for example, setting of finishing process such as stapling process or cutting process) that cannot be processed in the printer is set”. In this case, it is preferable to display a proposal of print setting that does not require the option setting. Further, as the display of the error data in the print system 100, it is also possible to display a message “Network is offline”. In this case, it is preferable to display an available network.

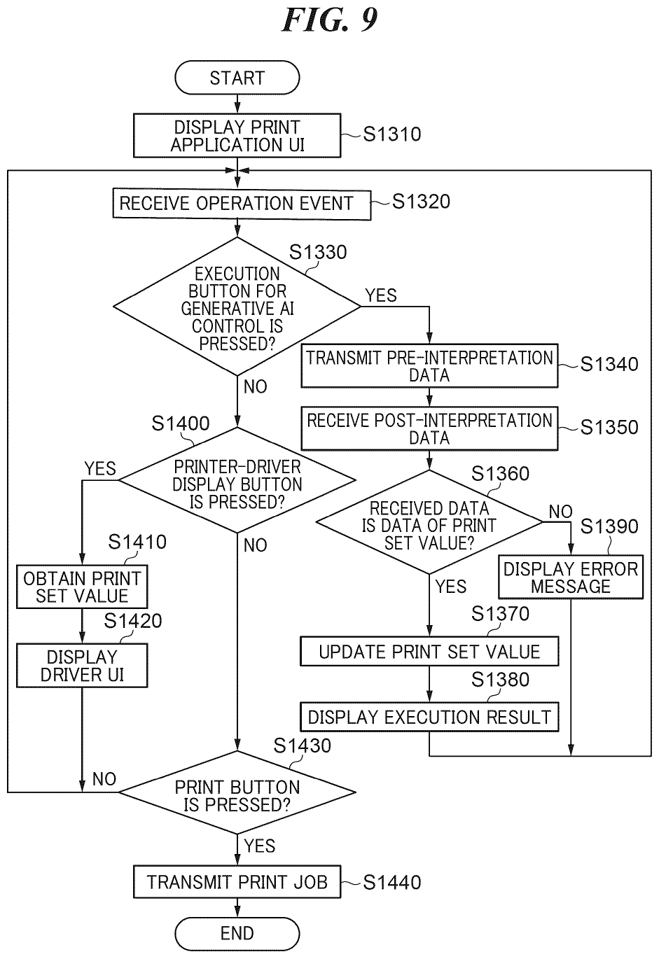

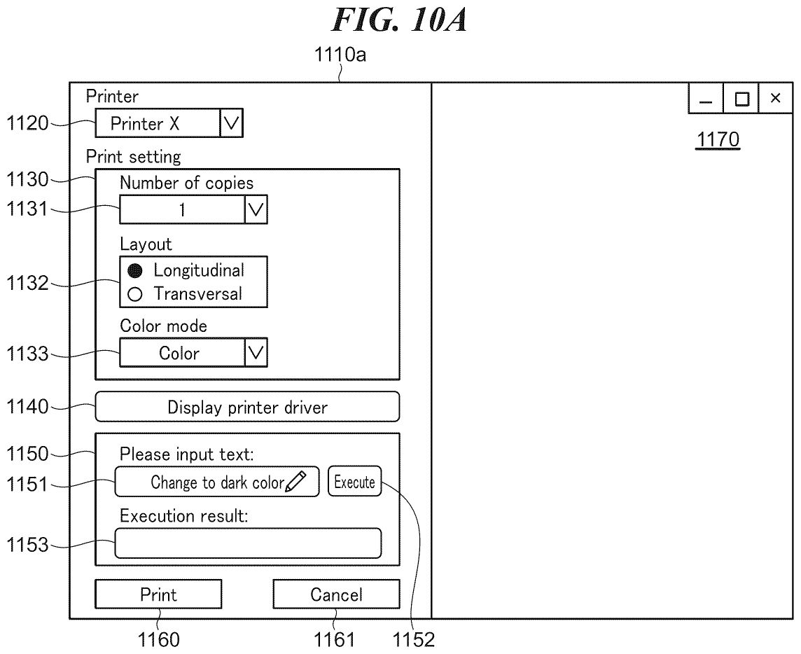

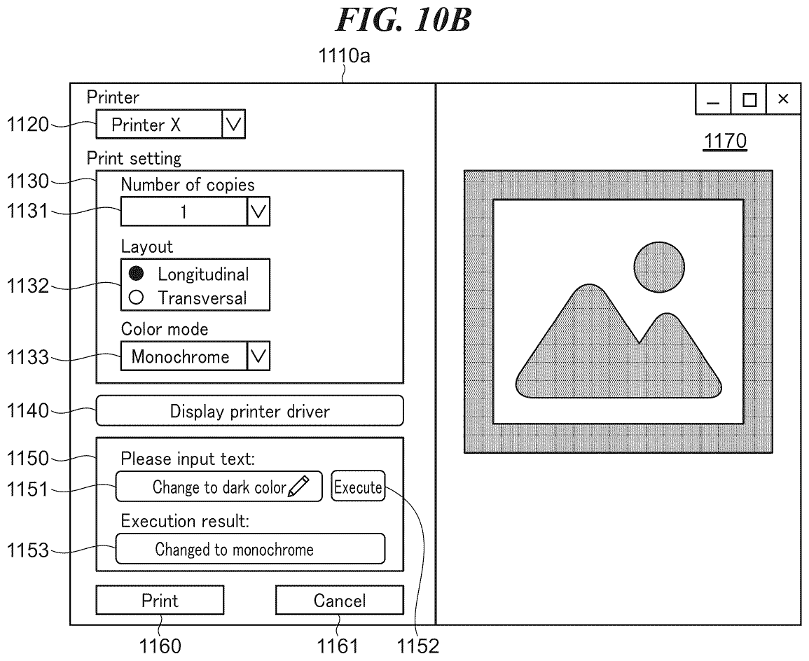

FIG. 9 is a flowchart showing an example of the print process executed by the print application. FIGS. 10A and 10B are views showing examples of images of the print application UI sequentially displayed during the print process executed by the print application. All the steps in the flowchart shown in FIG. 9 are achieved by the CPU 1041 executing the print application 1110 loaded into the memory 1042 from the storage unit 1030 of the computer 1000. The process in the flowchart shown in FIG. 9 is started when the operation unit 1020 receives a UI display request of the print application 1110. As shown in FIG. 9, in a step S1310, the CPU 1041 displays the print application UI 1110a on the display device 1010. Thus, the user can perform an operation event to the print application UI 1110a. The “operation event” means that the setting operation is performed on the printer selection control 1120, the number-of-copies control 1131 to the color mode control 1133 of the print setting control 1130, and the text box 1151 of the generative AI control 1150. The user sets the print application UI 1110a to, for example, the state shown in FIG. 10A. In the state shown in 10A, the printer selection control 1120 is set to the “Printer X”. The number-of-copies control 1131 of the print setting control 1130 is set to “1”. The layout control 1132 is set to “Longitudinal”. The color mode control 1133 is set to “Color”. In the text box 1151 of the generative AI control 1150, “Change to dark color” is input and set. The execution result display box 1153 and the image display area 1170 are blank.

In a step S1320, the CPU 1041 receives the operation event to the print application UI 1110a. As described above, the operation event includes the input of a text to the text box 1151. Therefore, the step S1320 corresponds to a reception step of receiving input of a text from a user. Further, the operation event includes a selection of a printer on the printer selection control 1120. Therefore, the step S1320 also corresponds to a selection step of causing a user to select a printer as a transmission destination.

In a step S1330, the CPU 1041 determines whether the execution button 1152 of the generative AI control 1150 is operated, that is, pressed, on the print application UI 1110a in the state shown in FIG. 10A. As a result of the determination in the step S1330, when it is determined that the execution button 1152 is operated, the process proceeds to a step S1340. On the other hand, as a result of the determination in the step S1330, when it is determined that the execution button 1152 is not operated, the process proceeds to a step S1400.

In the step S1340, the CPU 1041 transmits the pre-interpretation data to the network communication unit 3050 of the generative AI server 3000 via the network communication unit 1050. The step S1340 corresponds to a transmission step of causing the computer 1000 to transmit the text received in the text box 1151 toward the generative AI server 3000. When the generative AI server 3000 receives the pre-interpretation data via the network communication unit 3050, the program based on the flowchart shown in FIG. 7 is executed. As a result, the generative AI server 3000 obtains the post-interpretation data as the execution result of the program. The generative AI server 3000 transmits the post-interpretation data to the network communication unit 1050 of the computer 1000 via the network communication unit 3050.

In a step S1350, the CPU 1041 receives the post-interpretation data from the network communication unit 3050 of the generative AI server 3000 via the network communication unit 1050.

In a step S1360, the CPU 1041 determines whether the post-interpretation data received in the step S1350 is the print set value data. Here, the print set value data shall be the above-described data of “Set to monochrome”. As a result of the determination in the step S1360, when it is determined as the print set value data, the process proceeds to a step S1370. On the other hand, as a result of the determination in the step S1360, when it is not determined as the print set value data, the process proceeds to step a S1390.

In the step S1370, the CPU 1041 updates the print set value data stored in the storage unit 1030. As a result, the print set value of the color mode control 1133 is forcibly changed from “Color (see FIG. 10A)” to “Monochrome (see FIG. 10B)” and displayed on the display device 1010. The process in the step S1307 is not limited to the forcible change of the print set value of the color mode control 1133 from “Color” to “Monochrome”. For example, a message indicating “May you change from “Color” to “Monochrome”?” may be displayed in a message box (not shown) or the image display area 1170. In this case, it is preferable to provide an OK button (not shown), change the print set value of the color mode control 1133 from “Color” to “Monochrome”, and display the changed print set value on the display device 1010, when the OK button is operated.

In a step S1380, the CPU 1041 displays the text “Changed to monochrome” based on the result of the determination that the post-interpretation data is the print set value data of “Set to monochrome” in the step S1360 in the execution result display box 1153 (see FIG. 10B). Further, the CPU 1041 displays the preview image (the printing result based on the secondary data) to which “Set to monochrome”, which is the interpretation result of “Change to dark color” input and set in the text box 1151 by the generative AI server 3000, is reflected in the image display area 1170 (see FIG. 10B). That is, the preview image is displayed on the basis of edited image data that is obtained by applying an editing process to the original image data by using the text interpreted by the generative AI server 3000. Thus, the user can confirm the state of the “Change to dark color” reflected in the printed matter before the printed matter is obtained. The step S1380 corresponds to a display step of displaying image data on the display device 1010 of the computer 1000 and a display control step of displaying the edited image data that is obtained by applying the editing process to the image data using the text and the generative AI on the display device 1010. After the execution of the step S1380, the process returns to the step S1320, and the subsequent steps are sequentially executed.

In a step S1390 after the execution of the step S1360, the CPU 1041 displays an error message (for example, “Interpretation of text failed”) in the execution result display box 1153. After the execution of the step S1390, the process returns to the step S1320, and the subsequent steps are sequentially executed.

In a step S1400 after execution of the step S1330, the CPU 1041 determines whether the printer driver control 1140 is operated on the print application UI 1110a in the state shown in FIG. 10A. As a result of the determination in the step S1400, it is determined that the printer driver control 1140 is operated, the process proceeds to a step S1410. On the other hand, as a result of the determination in the step S1400, when it is determined that the printer driver control 1140 is not operated, the process proceeds to a step S1430.

In the step S1410, the CPU 1041 obtains the print set value stored in the storage unit 1030.

In a step S1420, the CPU 1041 displays the driver UI 400 (see FIG. 5) on the display device 1010. At this time, the print application UI 1110a in the state shown in FIG. 10A is erased from the display device 1010. After the execution of the step S1420, the process returns to the step S1320, and the subsequent steps are sequentially executed.

In the step S1430 after the step S1400 is executed, the CPU 1041 determines whether the print button 1160 is operated on the print application UI 1110a in the state shown in FIG. 10A. As a result of the determination in the step S1430, when it is determined that the print button 1160 is operated, the process proceeds to step a S1440. On the other hand, as a result of the determination in the step S1430, when it is determined that the print button 1160 is not operated, the process returns to the step S1320 and the subsequent steps are sequentially executed.

In a step S1440, the CPU 1041 obtains the print set values stored in the storage unit 1030 and transmits the print job containing the print set values (a request to perform printing based on the edited image data) to the network communication unit 2050 of the printer 2000 via the network communication unit 1050. That is, the print button 1160 functions as a reception section that receives a print instruction to perform printing based on the edited image data. After the step S1440 is executed, the process is terminated. When receiving the print job via the network communication unit 2050, the printer 201 executes the print job to perform printing.

In the print system 100 having the above-described configuration, even when a text that is difficult to interpret by the printer 2000 is input to the text box 1151 of the print application UI 1110a, the text can be interpreted accurately (appropriately) by the generative AI server 3000. The interpretation result can be reflected to the print job by the print application 1110, and thus the printer 2000 can also print the printed matter to which the interpretation result is reflected. As described above, when the output condition in the printer 2000 is set in the print system 100, the setting is supported (assisted) by the generative AI server 3000, and the output condition can be automatically set easily and accurately.

Although the input unit for inputting the output condition in the printer 2000 is included in the computer 1000 in the embodiment, this is not limiting. The input unit may be included in at least one of the computer 1000, the generative AI server 3000, and the printer 2000. The input unit may be displayed on a browser UI such as Microsoft Edge™ or Google Chrome™, a print application UI, or a chat application UI such as Microsoft Teams.

In the above-described embodiment, the print settings, such as the number of copies, the layout, and the color mode, installed in the standard printer driver 1220 are described, this is not limiting. There is a case where a printer is provided with different functions, such as a staple setting and a bookbinding setting. Even in this case, the print setting can be automatically set as with the above embodiment by performing a process obtaining the device information of the printer in advance. Further, in the above-described embodiment, the print set value data stored in the storage unit may actually have a different data format, such as PrintTicket or DevMode, for transmission and reception, due to a difference in an OS or a printer driver. The above-described embodiment can be applied to transmission and reception in such various data formats. Although the process of automatically setting the print setting by the computer 1000 has been described in the above-described embodiment, this is not limiting. For example, when the copy function of the printer 2000 is used, the printer 2000 can automatically set the print setting. Further, although the description in the above embodiment assumes that the print job is transmitted to the printer 2000, this is not limiting. For example, the print job can be transmitted to a cloud service that is built on the application 1100.

In the print system 100, for example, the generative AI server 3000 (hereinafter, referred to as a “server”) may be located outside Japan, and the computer 1000 (hereinafter, referred to as a “terminal device”) may be located in Japan. In this case, the server can transmit the file and data to the terminal device, and the terminal device can receive the file and data. Even when the server is located outside Japan, the transmission and reception of file and data in the present system are performed integrally. Then, since the system functions by the terminal device in Japan receiving the file and data, it can be considered that the transmission and reception are performed in Japan. In this system, for example, even when the server is located outside Japan and the terminal device is located in Japan, the terminal device can perform the main functions of this system and the effects of the functions can be exhibited in Japan. For example, even if the server is located outside Japan, the system can be used in Japan by using the terminal device constituting the system located in Japan. The use of the system affects economic benefits of the patentees, for example.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD™), a flash memory device, a memory card, etc.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-000697, filed Jan. 5, 2024, which is hereby incorporated by reference herein in its entirety.

What is claimed is:

1. A non-transitory computer-readable storage medium storing a program causing an information processing apparatus to execute a method, the method comprising:
displaying image data on a display of the information processing apparatus;
receiving input of a text from a user; and
displaying edited image data that is obtained by executing, using the text received and a generative AI, an editing process to the image data on the display.

2. The storage medium according to claim 1, wherein the method further comprises displaying a reception section that receives a print instruction to perform printing based on the edited image data to which the editing process has been executed on the display.

3. The storage medium according to claim 2, wherein a request to execute printing based on the edited image data to which the editing process has been executed is transmitted to an image processing apparatus in response to reception of the print instruction via the reception section.

4. The storage medium according to claim 1, wherein a text indicating an execution result of the editing process is displayed on the display.

5. The storage medium according to claim 1, wherein the method further comprises causing a user to select an image processing apparatus as a transmission destination,
wherein the edited image data to which the editing process has been executed is transmitted to the image processing apparatus selected.

6. The storage medium according to claim 1, wherein the method further comprises causing the information processing apparatus to transmit the text received toward the generative AI.

7. The storage medium according to claim 1, wherein a text reception section that receives the text and the image data are displayed on a same screen.

8. The storage medium according to claim 1, wherein the program is a computer program for printing.

9. The storage medium according to claim 1, where the program is a printer driver.

10. A method for an information processing apparatus, the method comprising:
displaying image data on a display of the information processing apparatus;
receiving input of a text from a user; and
displaying edited image data that is obtained by executing, using the text received and a generative AI, an editing process to the image data on the display.

11. An information processing apparatus, comprising:
a memory device that stores a set of instructions; and
at least one processor that executes the set of instructions to:
display image data on a display of the information processing apparatus;
receive input of a text from a user,
display edited image data that is obtained by executing, using the text received and a generative AI, an editing process to the image data on the display.

12. The information processing apparatus according to claim 11, wherein the at least one processor executes the set of instructions to display a reception section that receives a print instruction to perform printing based on the edited image data to which the editing process has been executed on the display.

13. The information processing apparatus according to claim 12, wherein the at least one processor executes the set of instructions to transmit a request to execute printing based on the edited image data to which the editing process has been executed to an image processing apparatus in response to reception of the print instruction via the reception section.

14. The information processing apparatus according to claim 11, wherein the at least one processor executes the set of instructions to display a text indicating an execution result of the editing process on the display.

15. The information processing apparatus according to claim 11, wherein the at least one processor executes the set of instructions to:
cause a user to select an image processing apparatus as a transmission destination; and
transmit the edited image data to which the editing process has been executed to the selected image processing apparatus.

16. The information processing apparatus according to claim 11, wherein the at least one processor executes the set of instructions to transmit the text received toward the generative AI.

17. The information processing apparatus according to claim 11, wherein the at least one processor executes the set of instructions to display a text reception section that receives the text and the image data on a same screen.
